(19) United States
(12) Patent Application Publication
(10) Pub. No.: US 2017/0009930 A1
(43) Pub. Date: Jan. 12, 2017

(54) Pig and Pig Disc for a Pig

(71) Applicant: Rosen Swiss AG, Stans (CH)

(72) Inventors: Dirk LARINK, Nordhorn (DE); Tilman MÖNSTER, Lengerich (DE); Holger ROSENBLECK-SCHMIDT, Nordhorn (DE)

(21) Appl. No.: 15/115,406

(22) PCT Filed: Jan. 14, 2015
(86) PCT No.: PCT/EP2015/000051

§ 371 Date: Jul. 29, 2016

(30) Foreign Application Priority Data
Jan. 29, 2014 (DE) 10 2014 001 001.5

(51) Int. Cl. F16L 55/40; B08B 9/055

(52) U.S. Cl. CPC F16L 55/40; B08B 9/055; F16L 2101/30

(57) ABSTRACT

Pig for inspecting and/or cleaning pipelines which transport, in particular, oil, gas or water, wherein the pig has at least one flexible plastic element which is mounted on a pig element which is preferably embodied as a pig body, wherein the plastic element has, viewed from the pig element, at least one electromechanical transducer, extending in the longitudinal direction of the plastic element, for detecting and/or outputting a change in shape of the plastic element. Furthermore, the invention relates to a pig disc in the elastic side region of which there is at least one electromechanical transducer as a sensor for detecting changes in the free internal cross section of a pipeline.

### BACKGROUND

The present invention relates to a pig for inspecting and/or cleaning pipelines which transport, in particular, oil, gas or water, wherein the pig has at least one flexible plastic element which is mounted on a pig element which is preferably embodied as a pig body. Furthermore, the present invention relates to a pig disc for a pig which can be used in a pipeline, said pig comprising a disc body with an inner attachment region for securing the pig disc to a pig body and an external region which adjoins the inner attachment region toward the outside with respect to a central axis and which can enter at least partially into contact with an inner side of the pipeline.

In order to protect inspection pigs or cleaning pigs it is customary in practice previously to travel through the pipelines with a relatively cost-effective pig which has a pig disc made of aluminium. This pig disc is attached to the body of the pig. The external diameter of this pig disc which is also referred to as a “gauging plate”, corresponds approximately to the diameter of a sensor ring of an inspection pig which is to be used. As a result of damage or destruction of the gauging plate, structural irregularities in the pipeline are indicated. Such irregularities can be, for example, deposits or dents in the pipeline, connections, for example of unauthorized extraction points or rusting and splitting welded connections, which project into the pipeline.

A problem when detecting these structural irregularities is the lack of spatial resolution. For instance, as a result of the use of the gauging plate it is not precisely known where the potential risks for the inspection pig are located in the pipeline in the direction of the longitudinal extent (z direction) thereof, and at what time of day (x-y plane). In addition, there is a risk that owing to previous damage or partial destruction of the gauging plate obstacles which occur in chronological succession cannot be correctly interpreted.

A further possible way of identifying the structural irregularities which are present in a pipeline is the use of inspection pigs which can measure the “free span” or the internal geometry of pipelines in a mechanical way, i.e. in particular by means of the deflection of a multiplicity of movable arms. However, as inspection pigs these pigs are already mechanically relatively complex and owing to their cost have to be protected against contact with excessively large irregularities which can damage the pig. Therefore, in advance of such an inspection pigs with gauging plates are in turn used.

There is therefore a need to make available a cost-effective pig for inspecting pipelines, in particular with the structural irregularities described.

### SUMMARY

The object is achieved by means of a pig according to claim 1 and by means of a pig disc according to claim 15 as well as ultimately by means of a pig according to claim 29. Advantageous refinements of the invention are presented in the dependent claims and this description.

According to the invention, a pig having at least one flexible plastic element which is mounted on a pig element is distinguished in that the plastic element has, viewed from the pig element, at least one electromechanical transducer, extending in the longitudinal direction of the plastic element, for detecting and/or outputting a change in shape of the plastic element. Alternatively or additionally, the electromechanical transducer can also be used as a generator for generating energy in the pipeline. By dispensing with complex lever mechanisms, the rigidity and the flexibility which is inherent in the plastic element, i.e. its flexibility in a direction transverse with respect to the longitudinal direction of the plastic element, are utilized in order to execute or detect changes in shape of the plastic element by means of the electromechanical transducer. In this context, the electromechanical transducer experiences or brings about a change in shape which corresponds to the change in shape of the plastic element or accompanies it. In an extreme case, the electromechanical transducer can form essential components of the plastic element.

Such a pig according to the invention is more favourable to manufacture since the manufacture of the plastic element is generally more favourable than the manufacture of metallic components. Furthermore, integration of an electromechanical transducer in the form of a sensor or an actuator is more easily possible, regardless of whether it is inside or at least partially outside on the plastic element. The transducer is precisely as flexible as the plastic element, to be precise in particular in the transverse direction with respect to its longitudinal extent. The supply of energy to the electromechanical transducer can, as in the case of conventional sensors, also either be integrated locally very close to the sensor and, for example, in the plastic element, but it can also be cabled to a pig element or located on another part of the pig.

The plastic element is typically of elastic design, i.e. it can return to its initial position after changes in shape which have been brought about owing to internal forces (of the transducer) or as a result of a change in the pipeline geometry.

An extent of the transducer in the longitudinal direction is understood to mean an extent starting from the attachment over at least 30% along the extension of the plastic element. A relatively large change in shape can preferably be brought about or detected in an improved way if at least 50% of the plastic element in the longitudinal direction is provided with a transducer. A plurality of transducers can also be provided in the plastic element, whether running one after the other or parallel to one another in the longitudinal direction.

The plastic element advantageously connects the pig element to a further pig part, for example a pig head or a further pig segment, i.e. a second pig part which is spaced apart from a first pig component in the longitudinal direction of the pig and connected, in particular, in an articulated fashion. The further pig part is, however, preferably a component which is offset radially outwards from a longitudinal central axis of the pig and is to be positioned, for example, right against an inner wall of the pipeline.

However, the plastic element can alternatively or additionally also be used to connect a plurality of pig segments, which entails the advantage of being able to detect, or bring about, corresponding relative positions of the segments well by means of the transducer and correspondingly to permit the pig to be oriented, for example for insertion into pipeline junctions.

Correspondingly, the transducer is designed, in particular, to generate a force transversely with respect to its longitudinal extent in order to change a relative position of the pig element with respect to the pig part. The transducer is at least embodied in a flat and longitudinally extended fashion in the form of a rod or else a plate. Said pig can have a multiplicity of plastic elements with one and/or a plurality of transducers. Changes in shape around the pig can therefore be tracked in the circumferential direction by means of sensors which are correspondingly embodied as transducers. It is likewise possible to execute changes in shape in the circumferential direction about the longitudinal axis of the pig and in the direction of the inner wall of the pipeline. Changes in shape and measurements of changes in shape are possible in a relative fashion between two pig segments.

In order to improve the arrangement of a sensor head or a measurement of the internal geometry of the pipe, the transducer is preferably designed to amplify a force which can be applied to an inner wall of the pipeline by the scraper. Alternatively, it can firstly generate such a force.

It is preferably possible for a transducer which is operated as an actuator to be used as a sensor at times in which the operation of the transducer as an actuator is not required. All this requires is for the actuation electronics to be adapted. The same also applies to a transducer which is operated as a generator and which can be identical in design, for example in terms of electrodes and the dielectric, to the transducers which are operated as sensors or actuators. The pig can also have transducers which are embodied differently in or on one or more plastic elements, i.e. at least one transducer which is embodied as an actuator for applying force and at least one further transducer which is embodied as a sensor.

The described advantages become clear in particular when the plastic element and the transducer have elasticity values which do not differ from one another by more than 25%.

In particular, the transducer can have a dielectric which is enclosed by electrodes, which permits easy manufacture of the transducer. At the same time, the dielectric can be embodied on a plastic basis and can therefore use plastics which are employed in a conventional way in the field of pipeline inspection or can be adapted to said plastics.

The dielectric is preferably manufactured on the basis of an elastomer which can be, in particular, a polyurethane. Polyurethanes, in particular in the field of Shore hardnesses A between 50 and 100 have very good extension properties and elasticity properties, low material costs and energy-efficient power consumption in respect of any dielectric embodiment, and a rapid response behaviour as well as a high level of reliability. It is also possible to achieve operation which is at least weight-neutral.

The electrodes can also be manufactured on the basis of a plastic, in particular of a polyurethane. Materials which are suitable for electrodes can be manufactured on the basis of soot, graphite, carbon nanotubes, metallic particles or conductive elastomer composites.

These advantages are found, in particular, in a transducer which is enclosed by a body made of polyurethane and/or a pig in which the plastic element is at least predominantly embodied from or on the basis of a polyurethane.

A layer of the transducer is preferably embodied at least partially on the basis of a soot-containing or barium-titanate-containing elastomer. The dielectric constant of the dielectric can also be increased by using suitable materials. Suitable materials are, in particular, conductive (for example soot-containing or graphite-containing) or highly polarizing organic or inorganic filler materials (in particular barium titanate). Highly polarizing materials are mainly materials whose dielectric constant is greater than 50. Correspondingly embodied transducers, in particular as sensors, can be manufactured themselves with only a low degree of expenditure.

An electrode of the transducer can preferably also be embodied at least partly on the basis of a carbon nanotube-containing, graphite-containing, soot-containing or metal-powder-containing material, and corresponding materials can be integrated well into polyurethane plastic.

A sensor or actuator with a dielectric based on a polyurethane which comprises, in particular, the filler materials designated above has, in comparison to other non-modified elastomers (for example silicone) a high dielectric constant, with the result that under constant conditions the sensor area which is necessary for a capacitance of, for example, 1 nF can be reduced to 10 cm² and therefore within a practical range. Alternatively, the layer thickness is to be correspondingly increased. The layers of the sensor are correspondingly easier to handle and can be subjected to greater loads.

According to a further embodiment of the invention the transducer can preferably be twisted in such a way that it is flexible in the axial direction and in the circumferential direction. In the circumferential direction means here about the longitudinal direction of the plastic element. This can be brought about, for example, by means of two transducers which run in parallel and which apply forces to the plastic element in different directions and therefore to one another.

Generally, a pig with a plastic element which has an electromechanical transducer is preferably embodied on the basis of a low expenditure in terms of material, simple design and a high and good level of ability to negotiate bends. In particular, the high flexibility of the possible plastics and the integration of the measurement device into these plastic elements allow for small embodiments of the pig.

Sensors which are constructed as flexible sensors on the basis of elastomers can be applied, but other conductive plastics, for example with a conductive soot or elastomers which are filled similarly are also possible. Correspondingly, on the one hand, changes in capacitance, resistance or voltage (in particular in the case of piezoelectric materials) can be detected and either stored or evaluated directly by an associated measuring electronics system. In addition to the dielectric, the sensor then has, as do any actuators, at least two electrode layers. In the case of three or more layers, the transducer can have two or more layers of the dielectric.

The use of a plurality of sensors can also be used to measure differences, during which the sensor signals are subtracted and therefore any temperature effects or pressure effects or other external effects on the sensors can be compensated.

According to the invention, in the case of a further solution of the object stated at the beginning there is provision that in the case of a pig disc for a pig which can be used in a pipeline and for detecting changes in the free internal cross section of the pipeline, comprising a disc body with an inner attachment region for securing the pig disc to a pig body and an external region which adjoins the attachment region further toward the outside with respect to a central axis and which can enter at least partially into contact with an inner side of the pipeline, at least the elastic external region has at least one electromechanical sensor for detecting the changes (in the free internal cross section of the pipeline). Changes in shape of the elastic external region can be registered by the electromechanical sensor. For this, changes in the resistance of the sensor or preferably changes in the capacitance of the sensor can be registered by an associated measuring system or measuring electronics. Owing to the elasticity of at least the external region, the pig disc can return or spring back into the previous shape again after travelling over the structural irregularity, with the result that a change in the free internal cross section which is present at the same time downstream in the pipeline can be subsequently detected. Structural irregularities within the pipeline therefore bring about reversible changes in the shape of the pig disc, which changes are detected by means of the electromechanical sensor. If the pig disc is introduced into the pipeline under prestress or with pre-extension, not only tapering but also enlargement of the free internal cross section of the pipeline can be registered by the sensor. The pig disc can extend in the case of enlargement of the cross section and therefore, in contrast to previous gauging plates, can, for example, detect abrasions in coatings or dents towards the outside. The relaxation of the disc segment or of the disc body which is brought about by this can be registered with the electromechanical sensor and leads, for example, to a change in capacitance, resistance or voltage which is registered by the measuring electronics.

The pig disc can consequently be a flexible plastic element according to claim 1, and the pig element can correspondingly be embodied as a pig body for securing the pig disc.

In order to protect the pig disc, it can have at the end side an edge protection along its circumference, by means of which edge protection the pig disc brings about defined bearing against the inner wall of the pipe. This edge protection can preferably be composed of a hard metal or a ceramic metal, for example of zirconium dioxide. The shape of the edge protection can have at least partially a round or else pointed shape in order to achieve improved sensing of the inner wall of the pipeline.

Of course, the sensor values which can preferably be detected as changes in the capacitance or resistance of the sensor can be detected electrically or electronically by means of a suitable measuring or detection system and stored, and if appropriate, even already evaluated. This measurement and/or detection system can be part of the pig disc; however, in order to avoid excessively high costs when exchanging a worn pig disc it can be advantageous to assign the significant parts of the detection system to an associated pig and to accommodate them, for example, in the body of the pig. The pig disc is then assigned a measurement and/or detection system which has means for detecting any changes in the resistance or the capacitance of the electromechanical sensor. During operation of the transducer as an actuator a corresponding actuation electronics system is also present on the pig. The latter comprises means for supplying voltage and associated control and storage means. Analogously, when the transducer is used as a generator the associated electronics will have means for receiving the voltage generated by the mechanical forces acting on the transducer. The energy which is extracted from the transducer can then be consumed or stored using storage means.

In particular, the sensor is of flexible design such that it can correspondingly execute changes in the shape of the pig disc caused by cross-sectional changes of the pipeline. For this purpose, the sensor can either be arranged on the outside of the pig disc or integrated therein or can at least also partially form the pig disc. After the obstacle or the irregularity in the pipeline has been travelled past, the pig disc which is attached to a pig can return, together with the sensor, to the shape which corresponds to the initial state before the structural irregularity.

The central axis is an axis which leads through the centre of the typically circular pig disc and which is positioned perpendicularly on the plane of the pig disc which is spread out flat. If the pig disc is not embodied as a flat disc in an unloaded state but instead, for example, has regions which are bent toward the rear counter to a direction of travel to be assumed, the longitudinal axis of the pig disc corresponds to the longitudinal axis of the pig in the installed state of the pig disc.

In order to eliminate temperature effects, in a further embodiment according to the invention there is provision that the disc body has, viewed in the axial direction, at least two sensors which are arranged one behind the other and preferably spaced apart from one another and which are, in particular, introduced into the disc body or arranged on the pig disc. In order to determine precisely the deflection or change in shape of the pig disc, the two sensors are connected in a detection device in such a way that it is possible to measure the difference between the sensor signals or to subtract the sensor signals. As a result of the latter, any temperature effects or even other external influences, for example owing to pressure on the sensors, are compensated. Otherwise, temperature calibration is to be carried out for a sensor. In the case of deformation of the pig disc owing to a structural irregularity, for example owing to denting and a reduction in the internal cross section of the pipeline, in the case of sensors which lie one behind the other in the axial direction there is preferably, on the one hand, extension (of the front sensor in the direction of travel) and compression of the sensor located behind it in the direction of travel. If the sensors are capacitive sensors, this leads, on the one hand, to an increase in the capacitance and, on the other hand, to a reduction in the capacitance (rear sensors). The difference between the two capacitances is therefore greater than zero. Large deformations of the free internal pressure cross section give rise to large changes in capacitance and small deformations give rise to relatively small changes in capacitance.

Depending on the materials used for the sensor, calibration curves can be produced which can be stored in a database and subsequently used to evaluate runs present in a pipeline, in order to be able to quantify the changes in cross section. Alternatively, the change in shape of the pig disc can also be determined directly from the sensor data, either by analytical means or in a simplified approximate fashion.

The disc body preferably has in the circumferential direction a multiplicity of segments which are separated from one another and by means of which improved quantification of the irregularities is made possible. For example, the pig disc can be divided into disc segments, similarly to pieces of cake, wherein each disc segment preferably has at least one sensor which is introduced, in particular, into the pig body. As a result, the position of an obstacle in the pipeline can be determined better in the circumferential direction. In particular, by additionally using a position sensor to determine the orientation of the pig it is possible to carry out good determination in the X-Y plane as a function of the fine resolution of the segments.

In combination with a position encoder or timer it is furthermore also possible to determine unambiguously the location of obstacles occurring in succession. Given further use of a sensor which determines the orientation of the pig in the X-Y plane, the location of the structural irregularities can then be determined in all three dimensions in accordance with the resolution of the disc segments.

Further qualitative information about any structural irregularities can be detected when the disc body has, in the radial direction, a multiplicity of sensors which are arranged at least partially one behind the other.

The sensors are preferably sensors which have a dielectric which is enclosed by electrodes and which therefore measure at a capacitive level. In particular when an elastomer, in particular a polyurethane, is used as the dielectric, the pig disc according to the invention is defined by very good extension properties and elasticity properties, low material costs, an energy-efficient power consumption and, furthermore, by a rapid response behaviour, high level of reliability and operation which is virtually without noise and weight-neutral. Alternatively or additionally, the sensor can have a material from the group composed of graphite, graphene, soot, carbon nanotubes, metal powder for the electrode as well as silicone, polyacryl, rubber, fluororubber or other elastomers for the dielectric, again also with the advantages above. For the plastic element, which can also be the pig disc or a pig disc segment, and/or parts of the transducer, as well as polyurethane or other elastomers, for example, in particular, hydrated acrylnitrilebutadiene rubber or a fluoroelastomer, can be used.

The sensor has, as the dielectric, preferably at least 80% polyurethane, but preferably at least 95% and, in particular, at least 99% thereof. In contrast to, for example, silicone elastomers, a dielectric based on a polyurethane has a high dielectric constant, with the result that under constant conditions the sensor surface which is necessary for a capacitance of, for example, 1 nF can be reduced to 10 cm², or the layer thickness may be increased to 300 μm. This advantage is apparent in the minimization of the sensor system and simpler processing, since relatively thin films for the dielectric are relatively difficult to handle.

The dielectric constant and therefore the resolution of the sensor can be increased further by introducing additives, in particular barium titanate.

In order also to be able to make the electrode of the sensor extendable, a layer of a soot-containing elastomer is at least partially used for the electrode. Alternatively or additionally, the electrode of the sensor can be constructed at least partially from at least one layer of a carbon nanotube-containing, graphite-containing or metal-powder-containing material. In particular in combination with a carrier material based on polyurethane such a sensor system can be integrated extremely well into pig discs which are also manufactured from polyurethane. In an extreme case, such a pig disc can be composed completely of a sensor. However, one or two layers of electrodes are preferably enclosed in a pig disc, with the result that they are less susceptible to environmental influences in the pipelines.

Methods which are based on measurement of the electrical capacitance are, as described, very energy-efficient and only small electrical losses occur compared to resistance-based sensor systems. They are to be preferred to resistance-based measuring methods for operation in pipelines.

The sensor can preferably not only be extended or compressed in the longitudinal direction but is also of elastic design such that it is flexible in the axial direction and in the circumferential direction, to be precise preferably reversibly flexible, and can therefore be twisted.

The object which was stated at the beginning is also achieved by a pig for detecting changes in the free internal cross section of a pipeline, wherein the pig has a pig disc as described above or below. The described advantages also apply to the pig.

### BRIEF DESCRIPTION OF THE DRAWINGS

Further advantages and details of the invention can be found in the following description of exemplary embodiments. The schematic illustrations in the figures are as follows:

FIG. 1 shows a subject matter according to the invention in a plan view,

FIG. 2 shows a view of a detail of a subject matter according to the invention according to FIG. 1,

FIG. 3 shows a further subject matter according to the invention,

FIG. 4 shows the subject matter according to FIG. 3 in a partial view in a pipeline,

FIG. 5 shows a further subject matter according to the invention in a front view, and

FIG. 6 shows the subject matter according to FIG. 5 in a partial side view.

### DETAILED DESCRIPTION

Individual technical features of the exemplary embodiments described below can also be combined with exemplary embodiments described above and the features of the independent claims as well as any further claims to form subjects according to the invention. Where appropriate, identically functioning elements are provided with identical reference symbols.

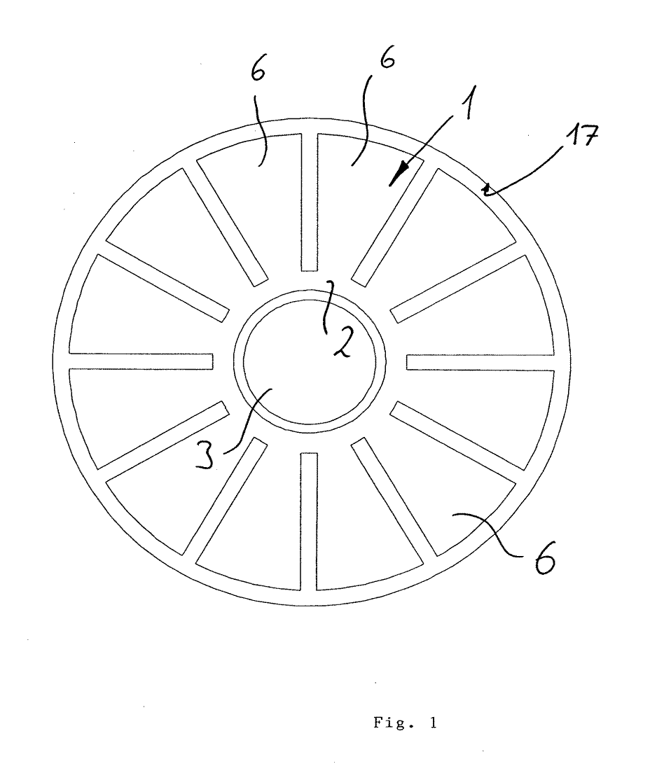

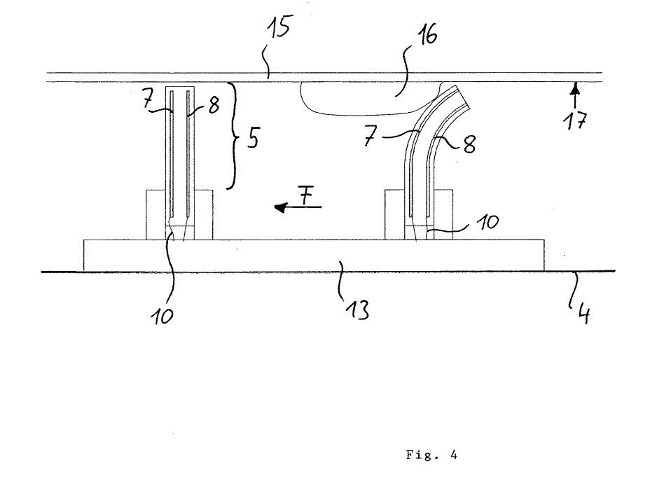

A pig disc according to the invention is provided according to FIG. 1 with a disc body 1 which has an inner attachment region 2 with a central recess 3. Starting from a central axis 4 which protrudes perpendicularly from the plane of the drawing in FIG. 1 and can be seen, for example, in FIG. 4, there is further toward the outside an adjoining external region 5 which comprises a multiplicity of segments 6 (cf. FIG. 4).

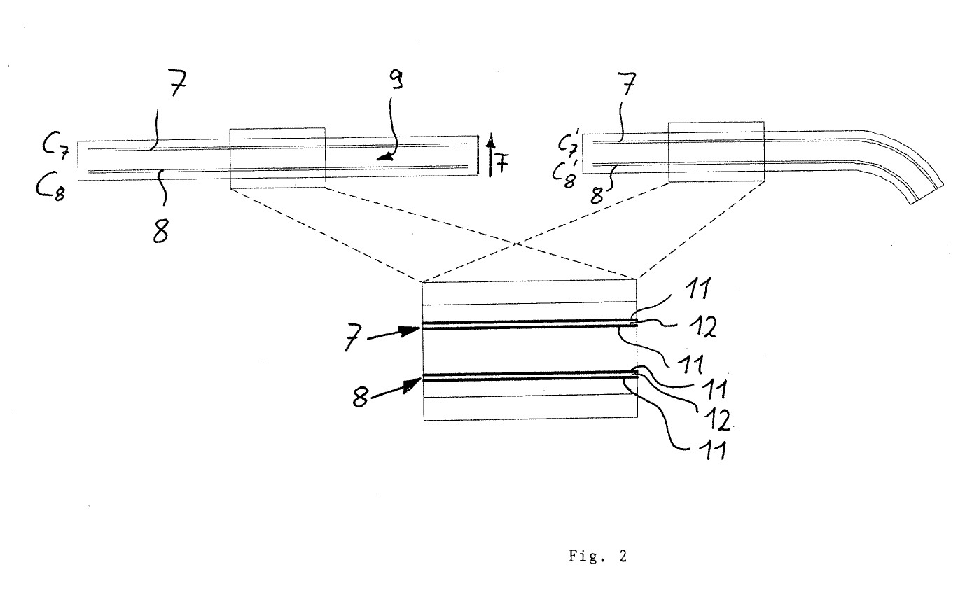

In the exemplary embodiment according to FIG. 1, segments 6 which are similar to pieces of cake are present in the circumferential direction 16. Each segment 6 has two sensors 7 and 8 which are arranged one behind the other in the axial direction and which are enclosed by the polyurethane 9 of the external region 7. Both the sensor 7 and the sensor 8 comprise flexible electrodes 11 which enclose a dielectric 12 based on a polyurethane. In the case of a structural irregularity, the pig disc is deformed, as can be seen in the upper right-hand part of FIG. 2. As a result, the sensor 7 which is at the front in the direction of travel F (cf. FIG. 4) experiences extension which leads to an increase in its capacitance, while the rear sensor which is located in the direction of travel F experiences compression and an associated reduction in its capacitance. Correspondingly the capacitance C₇′>C₇, and the capacitance C₈′<C₈. The axial direction corresponds to, or is opposed to, the direction of travel F.

As a result of the measurement of the differences between the capacitances of the two sensors 7 and 8 it is possible to obtain a change value which is influenced by the temperature and is proportional to the change in shape. The latter can be calculated analytically to form a change in shape of the electrodes and correspondingly provide information about the deformation of the pig disc. Said change value can also alternatively be approximated by means of a database comparison and empirical values of a deformation of the pig disc which are stored in the database and in this respect also provide information about the deformation thereof.

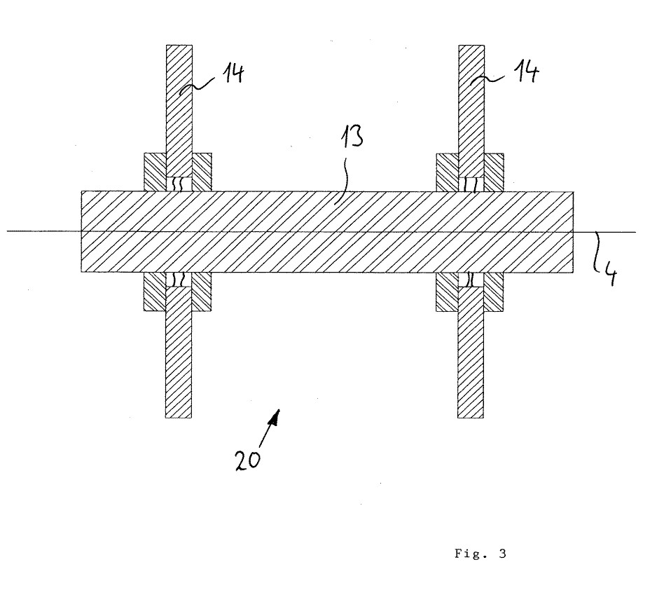

A pig 20 according to the invention, provided with two pig discs which are equipped as gauging plates, can be found in FIG. 3. In said figure, pig discs 14 which are attached to a pig body 13 and which correspond to the pig discs described above are attached. The detection of the changes in capacitance is carried out within the at least in parts hollow pig body. Additionally or alternatively, parts of the electronics could at least partially also be arranged in the pig disc. Within the pig body there are also units for detecting the changes in capacitance of the sensors and associated memory units. The sensors are correspondingly connected via cable 10 to the measuring unit or detection unit. The stored values can then be fed to an evaluation unit after the run via corresponding interfaces or already partially or completely initially or finally evaluated in a corresponding evaluation unit within the pig body. The location of structural irregularities 16 on an inner side 17 of a pipeline 15 (cf. FIG. 4) can be determined by means of associated further sensors which detect the position of the pig in the x-y plane and in the z direction, that is to say in the axial direction along the longitudinal axis 4. Correspondingly, subsequent cleaning runs and inspection runs of pigs can be carried out in a more targeted fashion.

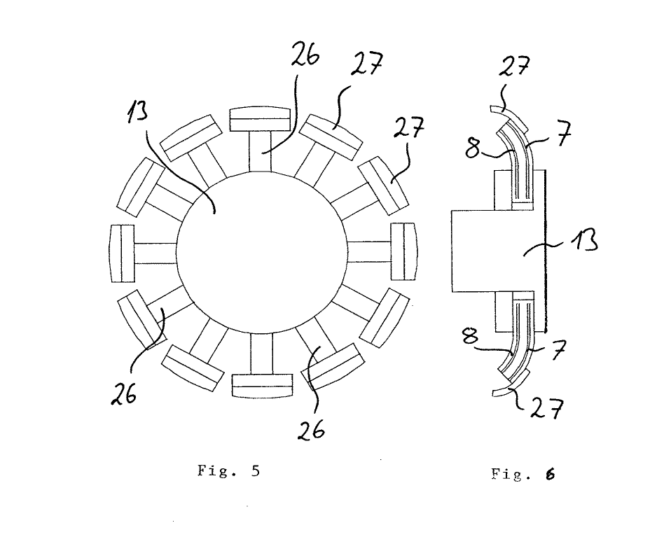

A further subject matter according to the invention according to FIGS. 5 and 6 has a multiplicity of elastic plastic elements 26 which produce a connection between a pig body 13 and further pig parts 27 in the form of sensing caps. Each plastic element 26 has on the inside two electromechanical transducers 7 and 8 which supply information about the curvature of the plastic element 26 and which can be evaluated by an associated evaluation electronics system.

1. A pig for inspecting and/or cleaning pipelines which transport, in particular, oil, gas or water, wherein the pig has at least one flexible plastic element which is mounted on a pig element which is preferably embodied as a pig body, wherein the plastic element has, viewed from the pig element, at least one electromechanical transducer, extending in the longitudinal direction of the plastic element, for detecting and/or outputting a change in shape of the plastic element.

2. The pig according to claim 1, wherein the plastic element connects the pig element to a further pig component.

3. The pig according to claim 1, wherein a multiplicity of transducers is arranged in and/or on the plastic element.

4. The pig according to claim 1, wherein the transducer is designed to generate a force transversely with respect to its longitudinal extent in order to change, in particular, a relative position of the pig element with respect to the pig component.

5. The pig according to claim 4, wherein the transducer is designed to amplify a force which can be applied to an inner wall of the pipeline by the pig.

6. The pig according to claim 1, wherein the transducer is embodied as a sensor.

7. The pig according to claim 1, wherein the plastic element is elastic, and the transducer is of flexible design such that it can correspondingly execute changes in the shape of the plastic element.

8. The pig according to claim 1, wherein the transducer has a dielectric which is enclosed by electrodes.

9. The pig according to claim 8, wherein the dielectric comprises an elastomer, in particular a polyurethane.

10. The pig according to claim 8, wherein the transducer is enclosed by a body made of polyurethane.

11. The pig according to claim 1, wherein the plastic element is predominantly embodied from polyurethane.

12. The pig according to claim 1, wherein a layer of the transducer is embodied at least partially on the basis of a soot-containing and/or barium-titanate-containing elastomer.

13. The pig according to claim 8, wherein an electrode of the transducer is embodied at least partly on the basis of a carbon nanotube-containing, graphite-containing, soot-containing or metal-powder-containing material.

14. The pig according to claim 1, wherein the transducer can be twisted in such a way that it is flexible in the axial direction and in the circumferential direction.

15. A pig disc for a pig which can be used in a pipeline and for detecting changes in the free internal cross section of the pipeline, comprising a disc body with an inner attachment region for securing the pig disc to a pig body and an external region which adjoins the attachment region further toward the outside with respect to a central axis and which can enter at least partially into contact with an inner side of the pipeline, wherein at least the elastic external region has at least one electromechanical transducer as a sensor for detecting the changes.

16. The pig disc according to claim 15, wherein the sensor is of flexible design such that it can correspondingly execute changes in the shape of the pig disc caused by the changes.

17. The pig disc according to claim 15, wherein the disc body has, viewed in the axial direction, at least two sensors which are spaced apart from one another.

18. The pig disc according to claim 15, wherein the disc body has, in the circumferential direction, a multiplicity of segments which are separated from one another.

19. The pig disc according to claim 18, wherein the disc body has at least one sensor per segment.

20. The pig disc according to claim 15, wherein the disc body has, in the radial direction, a multiplicity of sensors which are arranged at least partially one behind the other.

21. The pig disc according to claim 15, wherein the sensor has a dielectric which is enclosed by electrodes.

22. The pig disc according to claim 21, wherein the dielectric comprises an elastomer, in particular a polyurethane.

23. The pig disc according to claim 15, wherein the sensor is enclosed by a disc body made of polyurethane.

24. The pig disc according to claim 21, wherein the dielectric of the sensor has conductive or highly polarizing organic or inorganic filler materials, in particular barium titanate.

25. The pig disc according to claim 15, wherein an electrode of the sensor is embodied at least partially from at least one layer of a soot-containing elastomer.

26. The pig disc according to claim 15, wherein an electrode of the sensor is embodied at least partially from at least one layer of a carbon nanotube-containing, graphite-containing or metal-powder-containing material.

27. The pig disc according to claim 15, wherein the sensor can be twisted in such a way that it is flexible in the axial direction and in the circumferential direction.

28. The pig disc according to claim 15, comprising an edge protection.

29. The pig for detecting changes in the free internal cross section of a pipeline, comprising a pig disc according to claim 15.
